(19) United States
(12) Patent Application Publication
(10) Pub. No.: US 2016/0047726 A1
(43) Pub. Date: Feb. 18, 2016

(54) Method and Apparatus for Optimizing Sorptive Storage of Gas

(71) Applicant: Gas Technology Energy Concepts LLC, Buffalo, NY (US)

(72) Inventor: David Reichard, Getzville, NY (US)

(21) Appl. No.: 14/784,242

(22) PCT Filed: Apr. 15, 2013
(86) PCT No.: PCT/US2013/036644

§ 371 Date: Oct. 13, 2015

(51) Int. Cl. G01N 9/02; F17C 13/04; F17C 13/02; F17C 11/00

(52) U.S. Cl. CPC G01N 9/02; F17C 11/007; F17C 13/04; F17C 13/025; F17C 2205/0323; F17C 2221/033; F17C 2250/043; F17C 2250/0421; G01N 2009/022

(57) ABSTRACT

A system for optimizing storage of gas in a storage vessel includes a storage vessel, a gas supply source selectively coupled to the storage vessel to supply gas to the storage vessel, a pressure gauge to measure a pressure within the storage vessel, a plurality of adsorbent materials, a measurement device configured to determine at least one of a weight or a mass of at least the storage vessel, and a computing device. Each of the plurality of adsorbent materials is separately disposed in the storage vessel for individual evaluation. The computing device is communicatively coupled to the measurement device and configured to process information based on the measured weight or mass determined by the measurement device. The computing device is configured to determine a density, an adsorption capacity, and a deadsorption rate of each adsorbent material disposed in the storage vessel based on information determined by the measurement device.

### FIELD OF THE INVENTION

The present invention relates generally to a method and apparatus for sorptively storing a gas in a storage vessel having an adsorbent material therein. More particularly, the present invention relates to a method and apparatus for evaluating adsorbent materials to optimize the storage of natural gas in a storage vessel.

### BACKGROUND OF THE INVENTION

In gaseous fuel storage applications, it has been found that the use of high-surface-area adsorbent materials (i.e., adsorptive or absorbent materials) has provided for significantly increased storage capacities of such gases at relatively low pressures. However, it has also been found that not all of the gas adsorbed by the sorptive materials can be delivered from the storage vessel. Thus, while the use of adsorbent materials can increase the storage capacity of the storage vessel, the increased storage capacity is gained at the expense of the delivery capacity of the storage vessel.

### SUMMARY OF THE INVENTION

According to one aspect of the present invention, a method for optimizing storage of a natural gas in a storage vessel is described. The storage vessel has a valve for controlling the ingress and the egress of gases for the storage vessel. The storage vessel has an empty-vessel weight. The method includes providing a plurality of adsorbent materials. The plurality of adsorbent materials each have at least one of a different density or a different mesh size.

For each of the plurality of adsorbent materials, the method further includes disposing the adsorbent material in the storage vessel, determining an intermediate-vessel weight of the storage vessel and the adsorbent material disposed within the storage vessel, and filling the storage vessel with natural gas until a predetermined pressure is achieved within the storage vessel. A first portion of the natural gas is adsorbed by the adsorbent material. The method also includes, for each of the plurality of adsorbent materials, determining a first filled-vessel weight of the storage vessel filled with the natural gas to the predetermined pressure and the adsorbent material, and opening the valve to allow the natural gas to egress from the storage vessel until natural gas substantially ceases to egress from the storage vessel. A second portion of the adsorbed natural gas remains adsorbed by the adsorbent material after the natural gas has substantially ceased to egress from the storage vessel. After the natural gas has substantially ceased to egress from the storage vessel, the method also includes determining a first deadsorbed weight of the storage vessel, the adsorbent material, and the second portion of the natural gas, determining an adsorption capacity based on the first filled-vessel weight and the intermediate-vessel weight, determining a deadsorption rate based on the first filled-vessel weight and the first deadsorbed weight, and determining a density of the adsorptive material based on the empty-vessel weight and the intermediate-vessel weight. The method further includes selecting one of the plurality of adsorbent materials by comparing the adsorption capacities, the deadsorption rates, and the densities determined for each of the plurality of adsorptive materials.

According to another aspect of the present disclosure, computer readable storage media is encoded with instructions for directing a system to perform the above methods.

According to additional aspects of the present disclosure, a system for optimizing storage of natural gas in a storage vessel includes at least one storage vessel including a shut-off valve configured to control the ingress and egress of gases from the at least one storage vessel, a gas supply source selectively coupled to the storage vessel to supply gas to the at least one storage vessel, a pressure gauge to measure a pressure within the at least one storage vessel, a plurality of adsorbent materials, a measurement device configured to determine at least one of a weight or a mass of at least the at least one storage vessel, and a computing device. Each of the plurality of adsorbent materials is separately disposed in the at least one storage vessel for individual evaluation. The computing device is communicatively coupled to the measurement device and configured to process information received based on the measured weight or mass determined by the measurement device. The computing device is configured to determine a density, an adsorption capacity, and a deadsorption rate of each adsorbent material disposed in the at least one storage vessel based on information determined by the measurement device.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 illustrates an exemplary gas storage vessel and gas supply source according to some aspects of the present disclosure.

FIG. 2 illustrates an exemplary system for optimizing the storage of gas within a storage vessel according to some aspects of the present disclosure.

FIG. 3 illustrates an exemplary process for optimizing the storage of gas within a storage vessel according to some aspects of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

The present disclosure provides systems and methods for evaluating adsorbent materials within a storage vessel to optimize the storage of gases in the storage vessel. It should be noted that the terms “adsorbent” and “adsorptive”, and the like, as used herein, refer to the use of either a sorbent, sorptive, or an absorbent material.

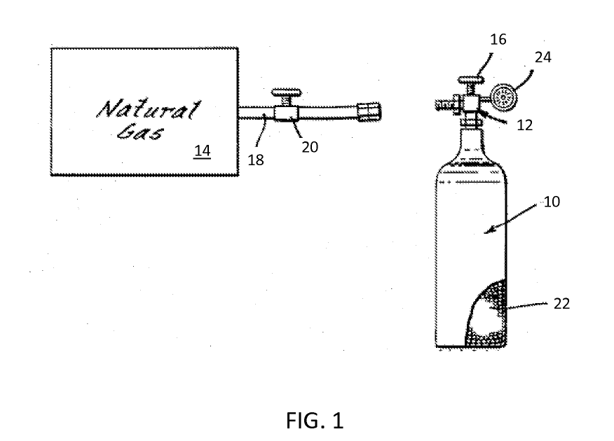

Referring to FIG. 1, an exemplary storage vessel 10 for storing a gas and an exemplary gas supply source 14 for supplying a gas (e.g., natural gas) to the storage vessel 10 are illustrated. The storage vessel 10 includes an inlet/outlet apparatus 12 configured to allow the storage vessel 10 to be selectively coupled and decoupled in fluid communication with a gas supply source 14. According to some aspects of the present disclosure, the inlet/outlet apparatus 12 can include a shut-off valve 16 configured to selectively open and close the fluid communication between the storage vessel 10 and the gas supply 14. Additionally, the storage vessel 10 can include a pressure gauge 24 configured to indicate a pressure within the storage vessel 10.

The gas supply source 14 includes a conduit or pipe 18 configured to be selectively coupled and decoupled with the inlet/outlet apparatus 12. The gas supply source 14 can further include a shut-off valve 20 configured to selectively control the flow of gas from the gas supply source 14.

According to aspects of the present disclosure, the storage vessel 10 further includes an adsorbent material 22. It is contemplated that the storage vessel 10 can optionally include a filter (not shown) that is configured to inhibit inadvertent or unintentionally egress of the adsorbent material 22 from the storage vessel 10.

The adsorbent material 22 is configured to isothermally adsorb a portion of the gas stored within the storage vessel 10. Adsorbent materials 22 that are configured to isothermally absorb a gas can be comprised of one or more of a plurality of different material types. For example, the adsorbent material 22 can include activated carbon, zeolite, silica gel, clay, combinations thereof, and/or the like. Non-limiting examples of an activated carbon include wood-based carbons, carbons derived from coconut shells, or synthetically manufactured carbons.

The adsorbent materials 22 also can be configured to have one of a plurality of different mesh sizes. As is known to the skilled artisan, the mesh size relates to the pore sizes on the surface of the adsorbent material 22. For example, an activated carbon material may have a surface area with a mixture of void spaces and/or small micropores, larger macropores, and/or mesopores from which a gas adsorbed in the adsorbent material (i.e., the activated carbon) can escape. That is, the mixture of surface features and/or void spaces can be expressed as the mesh size and the distribution of such features can affect the storage capacity (i.e., the capability of the adsorbent material to adsorb gas) of the adsorbent material 22 as well as the release capacity (i.e., the capability of the adsorbent material 22 to deadsorb gas) of the adsorbent material.

Additionally, the amount or density of the adsorbent material 22 within the storage vessel 10 can affect the storage capacity and the release capacity of the storage vessel. A problem is thus presented as to how to select an adsorbent material 22 from a plurality of potential adsorbent materials 22 comprising different material types, different mesh sizes, and/or different densities.

The storage capacity and the release capacity of the adsorbent material 22 are significant factors for assessing the performance of a storage vessel 10. The storage capacity of the adsorbent material 22 within the storage vessel 10 is always greater than the release capacity of the adsorbent material 22. Thus, although a particular adsorbent material 22 may have a high storage capacity, if the adsorbent material 22 cannot release a sufficient amount of the stored gas, unacceptable amounts of gas would be wasted and the adsorbent material 22 would not be suitable for commercial purposes.

The storage capacity and the release capacity of an adsorbent material 22 are not the only factors to be considered in optimizing the storage of gas in the storage vessel 10. Additionally, the cost of the adsorbent material 22 can be considered to determine the viability of an adsorbent material 22 for commercial purposes. The cost of an adsorbent material 22 is generally related to the density of the adsorbent material 22 as adsorbent materials 22 are generally sold on a per pound basis (or unit of weight basis). The systems and methods of the present disclosure can be utilized to evaluate the storage capacity, the release capacity, and the cost of one or more adsorbent materials 22 to optimize the storage of gases in storage vessels 10.

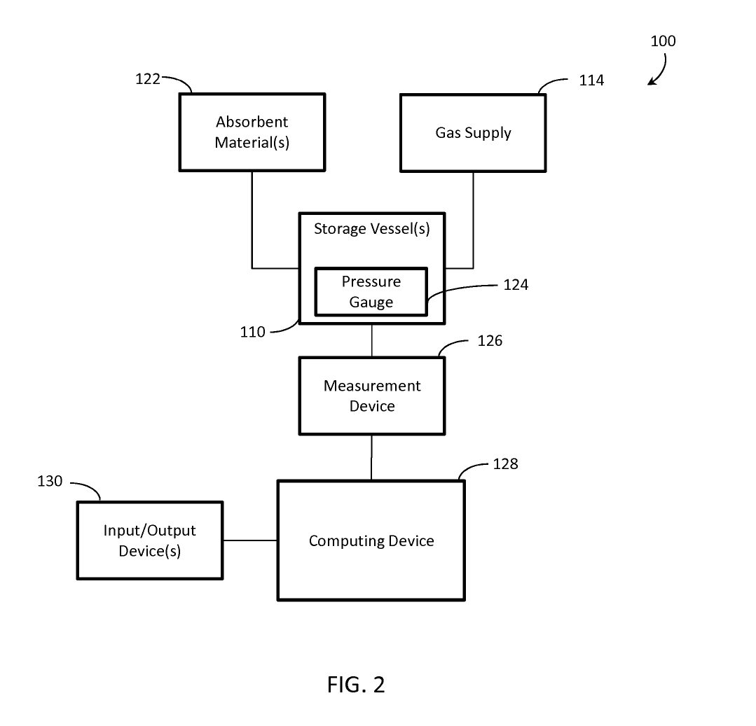

Referring to FIG. 2, a functional block diagram of a system 100 for optimizing storage of natural gas in a storage vessel 110 (e.g., the storage vessel 10 described and illustrated with respect to FIG. 1) is illustrated according to some aspects of the present disclosure. As shown in FIG. 2, the system 100 includes a storage vessel 110, one or more adsorbent materials 122, a pressure gauge 124, a gas supply source 114, a measurement device 126, a computing device 128, and one or more input/output devices 130.

As described above, the storage vessel 110 is configured to store a gas, the gas supply source 114 is configured to supply the gas to the storage vessel 110, and the pressure gauge 124 is configured to provide an indication of a pressure within the storage vessel 110. Additionally, as described above, the one or more adsorbent materials 122 are each configured to be disposed within the storage vessel 110, and absorb a portion of the gas within the storage vessel 110.

The storage vessel 110 is communicatively coupled to the measurement device 126. The measurement device 126 is configured to measure and provide an indication of a weight and/or mass of the storage vessel 110 (and/or any other components in or on the storage vessel 110 such as, e.g., the inlet/outlet 12, the pressure gauge 24, the shut-off valve 16, etc.). For example, as will be described in detail below, the measurement device 126 can be configured to measure a weight of the storage vessel 110 alone, a weight of the storage vessel 110 with an adsorbent material 122 disposed within the storage vessel 110, a weight or a mass of a gas stored within the storage vessel 110, and/or a weight or a mass of the gas released from the storage vessel 110. As one non-limiting example, the measurement device 126 can include a weighing scale configured to measure and provide an indication of a weight. As additional and/or alternative non-limiting example, the measurement device 126 can include a mass flow meter configured to measure the mass per unit time of the gas flowing into and out of the storage vessel 10. For example, the mass flow meter can be coupled to the inlet/outlet apparatus 12.

The measurement device 126 is communicatively coupled to the computing device 128. The computing device 128 can include one or more processors configured to receive and process information based on the measurements by the measurement device 126. Generally, the processor(s) may be implemented as a combination of hardware and software elements. The hardware aspects may include combinations of operatively coupled hardware components including microprocessors, logical circuitry, communication/networking ports, digital filters, memory, or logical circuitry. The processor(s) may be adapted to perform operations specified by a computer-executable code, which may be stored on a computer readable medium.

As described above, the processor(s) may be a programmable processing device, such as an external conventional computer or an on-board field programmable gate array (FPGA) or digital signal processor (DSP), that executes software, or stored instructions. In general, physical processors and/or machines employed by embodiments of the present disclosure for any processing or evaluation may include one or more networked or non-networked general purpose computer systems, microprocessors, field programmable gate arrays (FPGA's), digital signal processors (DSP's), micro-controllers, and the like, programmed according to the teachings of the exemplary embodiments of the present disclosure, as is appreciated by those skilled in the computer and software arts. The physical processors and/or machines may be externally networked with the image capture device(s), or may be integrated to reside within the image capture device. Appropriate software can be readily prepared by programmers of ordinary skill based on the teachings of the exemplary embodiments, as is appreciated by those skilled in the software art. In addition, the devices and subsystems of the exemplary embodiments can be implemented by the preparation of application-specific integrated circuits or by interconnecting an appropriate network of conventional component circuits, as is appreciated by those skilled in the electrical art(s). Thus, the exemplary embodiments are not limited to any specific combination of hardware circuitry and/or software.

Stored on any one or on a combination of computer readable media, the exemplary embodiments of the present disclosure may include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present disclosure for performing all or a portion (if processing is distributed) of the processing performed in implementations. Computer code devices of the exemplary embodiments of the present disclosure can include any suitable interpretable or executable code mechanism, including but not limited to scripts, interpretable programs, dynamic link libraries (DLLs), Java classes and applets, complete executable programs, and the like. Moreover, parts of the processing of the exemplary embodiments of the present disclosure can be distributed for better performance, reliability, cost, and the like.

Common forms of computer-readable media may include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

The computing device 128 is communicatively coupled to the input/output device(s) 130. The input/output device(s) 130 are configured to receive inputs from an operator of the system 100 and/or provide outputs to an operator of the system 100. As non-limiting examples, the input/output device(s) 130 can include one or more display areas for displaying information associated with the evaluation of the adsorbent materials 122 and/or the operation of one or more components of the system 100 to an operator. Additionally, for example, the input/output device(s) 130 can include touch screens, buttons, a mouse, a joystick, a keyboard, combinations thereof, and/or the like. The inputs received from an operator via the input/output device(s) can be transformed into electronic data signals that are processed by the computing device 128.

According to some aspects of the present disclosure, the measurement device 126 can be directly coupled to the computing device 128 such that the measurement device 126 can generate measurement signals indicative of measurements, which can be directly received and processed by the computing device 128. According to additional and/or alternative aspects, the computing device 128 can generate control signals that are received by the measurement device 126 to control the operation of the measurement device 126. In such aspects, the input/output device(s) 130 can optionally be utilized to cause the computing device 128 to generate at least some of the control signals.

According to alternative aspects of the present disclosure, the measurement device 126 may be indirectly coupled to the computing device 128. For example, information based on the measurements obtained by the measurement device 126 can be received by the computing device 128 via the input/output device(s) 130. According to such alternative aspects, the operator can utilize the input/output device(s) 130 to generate input signals that are received by the computing device 128 and indicative of the measurements obtained by the measurement device 126.

The measurement signals, the control signals, and/or the input signals can be selected from a group consisting essentially of an electrical current, an electrical voltage, an electrical charge, an optical signal, an optical element, a magnetic signal, and a magnetic element. It is contemplated that the signals can be transmitted and received via wired and/or wireless communications.

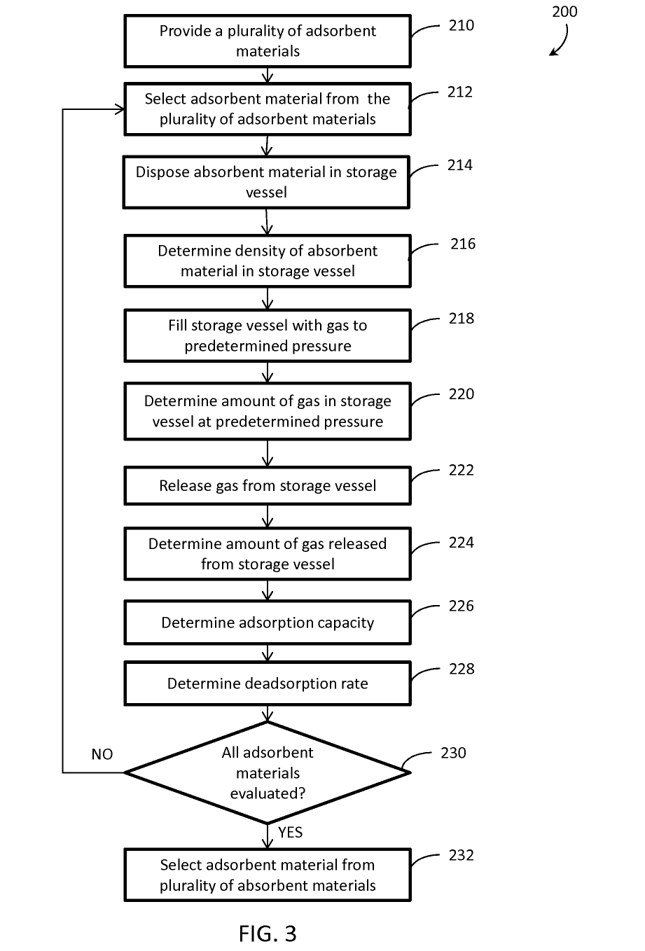

Referring now to FIG. 3, a process 200 for evaluating an adsorbent material 122 in a storage vessel 110 is illustrated and described in accordance with some aspects of the present disclosure.

At block 210 the process 200 is initiated by providing the plurality of adsorbent materials 122. At block 212, one of the adsorbent materials 122 is selected for evaluation. At block 214, the selected adsorbent material 122 is disposed within the storage vessel 110. As explained above, optionally, a filter (not shown) can be coupled to the storage vessel 110 to retain the selected adsorbent material 122 within the storage vessel 110.

At block 216, the density of the selected adsorbent material 122 within the storage vessel 110 is determined. For example, prior to the adsorbent material 122 being disposed within the storage vessel 110, the storage vessel 110 (including any additional components coupled thereto or disposed therein such as, e.g., a filter, the pressure gauge 124, the inlet/outlet apparatus 12, the shut-off valve 16, etc.) can be weighed by the measurement device 126 to determine an empty-vessel weight measurement. Then, after the adsorbent material 122 is disposed in the storage vessel 110 at block 214, the storage vessel 110 with the adsorbent material 122 disposed therein can be weighed by the measurement device 126 to determine an intermediate-vessel weight. The density of the selected adsorbent material 122 within the storage vessel 110 can thus be determined based on the measured empty-vessel weight and the measured intermediate vessel weight. In one exemplary implementation, the empty-vessel weight can be subtracted from the intermediate-vessel weight to determine a weight of the adsorbent material 122 within the storage vessel 110. The density of the adsorbent material 122 may then be determined by dividing the determined weight of the adsorbent material by a known (or previously measured) volume of the storage vessel 110.

According to some aspects, the determination of the density of the adsorbent material 122 at block 216 can be performed by the computing device 126 based on measurement signals received from the measurement device 126. According to additional and/or alternative aspects, the determination of the density of the adsorbent material 122 at block 216 can be performed by the computing device 126 based on input signals received from the input/output device(s) 130. As a non-limiting example, the measurement signals and/or the input signals can provide an indication of the empty-vessel weight, the intermediate-vessel weight measured by the measurement device 126, and/or the volume of the storage vessel 110.

At block 218, the storage vessel 110 is filled with gas supplied by a gas supply source (e.g., the gas supply source 14 illustrated in FIG. 1) until a predetermined pressure is achieved within the storage vessel 110. The pressure gauge 24 can be utilized to determine when the predetermined pressure is achieved. The shut-off valve 16 and/or the shut/off valve 20 can be utilized to cease the supply of gas from the gas supply source 14 to the storage vessel 110. It is contemplated that according to some aspects, the pressure gauge 24 can be communicatively coupled (e.g., via wired and/or wireless communication components) with the gas supply source 14 such that the gas supply source 14 automatically ceases to supply gas to the storage vessel 110 when the predetermined pressure is achieved. According to an additional and/or alternative embodiment, the pressure gauge 24 can be communicatively coupled (e.g., via wired and/or wireless communication components) with the shut-off valve 16 of the storage vessel 110 to cease the flow of gas from the gas supply source 14 to the storage vessel 110 in response to the predetermined pressure being achieved. As one non-limiting example, the predetermined pressure can be approximately 275 pounds per square inch (PSI). According to another non-limiting example, the predetermined pressure can be in a range from approximately 100 PSI to approximately 900 PSI.

At block 220, the amount of gas stored in the storage vessel at the predetermined pressure is determined. For example, the measurement device 126 can be utilized to weigh the storage vessel 110 including the adsorbent material 122 and the gas at the predetermined pressure to determine a filled-vessel weight. The intermediate-vessel weight can then be subtracted from the filled-vessel weight (e.g., via the computing device 128) to determine the weight of the gas within the storage vessel 110. As another example, the measurement device 126 can include a mass flow meter coupled to the storage vessel 110 and configured to measure a mass of the gas as the storage vessel 110 is filled at block 218.

At block 222, the gas within the storage vessel 110 is released, for example, by opening the shut-off valve 16 on the storage vessel 110. The shut-off valve 16 is opened until the gas ceases to freely egress from the storage vessel 110. At block 224, the amount of gas released from the storage vessel 110 at block 222 is determined. For example, the measurement device 126 can be utilized to weigh the storage vessel 110 (and any components attached thereto or remaining disposed therein) to determine a deadsorbed weight. As another example, if the measurement device 126 includes a mass flow meter, the measurement device 126 can determine a mass of the gas that egressed from the storage vessel 110 at block 222.

At block 226, an adsorption capacity for the adsorbent material 122 is determined. The adsorption capacity can be based on the amount of gas determined at block 220 (e.g., based on the intermediate-vessel weight and the filled-vessel weight and/or a measured mass of the gas supplied to the storage vessel at block 218). In one non-limiting implementation, adsorption capacity can be determined by the computing device 128 based on one or more input signals and/or measurement signals received from the input/output device(s) and/or the measurement device 126, respectively. For example, the adsorption capacity can be determined by dividing the volume of the storage vessel 110 by the weight of the gas determined at block 220. As another example, the adsorption capacity can be determined by multiplying the weight of the gas determined at block 220 by a predetermined ratio of the expected volume per unit of weight for the gas under normal conditions.

At block 228, a deadsorption rate for the adsorbent material 122 is determined. The deadsorption rate can be based on the amount of released gas determined at block 224 (e.g., based on the deadsorbed weight and the filled-vessel weight and/or a measured mass of the gas released to the storage vessel at block 222) and the amount of supplied determined at block 220 (e.g., based on the intermediate-vessel weight and the filled-vessel weight and/or a measured mass of the gas supplied to the storage vessel at block 218). For example, the amount of released gas can be divided by the amount of supplied gas to determine the deadsorption rate. In one non-limiting implementation, deadsorption rate can be determined by the computing device 128 based on one or more input signals and/or measurement signals received from the input/output device(s) and/or the measurement device 126, respectively.

At decision block 230, it is determined whether all of the adsorbent materials 122 have been evaluated. If at least one of the adsorbent materials 122 has not been evaluated, the process 200 returns to block 212. If it is determined at decision block 230 that all adsorbent materials 122 have been evaluated, the process 200 proceeds to block 232.

At block 232, one of the plurality of adsorbent materials 122 is selected from the plurality of adsorbent materials 122 based on the determined densities of the adsorbent materials 122, the determined adsorption capacities of the adsorbent materials 122, and the determined deadsorption rates of the adsorbent materials 122. The selection can include comparing the determined densities, adsorption capacities, and deadsorption rates to one or more evaluation criteria. The one or more evaluation criteria can include one or more predetermined threshold values and/or ranges of threshold values.

In one exemplary implementation, the adsorbent material 122 is selected by determining which of the plurality of adsorbent materials 122 has an adsorption capacity above a first predetermined threshold value, a deadsorption rate above a second predetermined threshold value, and a density below a third predetermined threshold value. According to a non-limiting example, the first predetermined threshold can be a value in a range from approximately 2.0 cubic feet/pound to approximately 3.4 cubic feet/pound, the second predetermined threshold can be a value in a range from approximately 58% to approximately 96%, and the third predetermined threshold can be a value in a range from approximately 13.98 cubic feet/pound to approximately 29.98 cubic feet/pound. As a result of the process 200, the adsorbent material 122 having a high adsorption capacity, a high deadsorption rate, and a low density can be selected.

It is contemplated that additional and/or alterative evaluation criteria can be utilized based on the measured and determined values as well. For example, the evaluation criteria can include a first threshold value for a ratio of deadsobed gas to adsorbed gas, a second threshold for the determined density, and/or a third threshold value for the ratio of gas deadsorbed to the cost of adsorbent (i.e., the density multiplied by the cost per unit of density). In one exemplary implementation, the adsorbent material can be selected based on a determination as to which of the plurality of adsorbent materials has a ratio of deadsorbed gas to adsorbed gas that is greater than approximately 80%, a density that is less than approximately 20 pounds per cubic foot, and/or a ratio of deadsorbed gas to cost of the adsorbent material that is less than approximately $1.50/cubic feet.

FIG. 3, described by way of example above, represents an exemplary process that corresponds to at least some instructions executed by the computing device 130 in FIG. 2 to perform the above described functions associated with the disclosed concepts. It is also within the scope and spirit of the present concepts to omit steps, include additional steps, and/or modify the order of steps presented above. As one non-limiting example, the determination of the adsorption capacity at block 226 can be performed after the determination of the deadsoprtion rate at block 222. As another example, the determination of the adsorption capacity at block 228 can be determined prior to the release of gas from the storage vessel 110 at block 222. As still another example, the determination at block 226 can be performed after the determination at block 220 but before the gas is released at block 222.

Additionally, for example, it is contemplated that the some of the steps performed for each adsorbent material 122 can be iteratively performed a plurality of times to confirm a pattern of performance for the adsorbent material 122. That is, for example, the steps at blocks 218, 220, 222, and 224 can be iteratively conducted for the process to confirm a pattern of performance and outlier data can be ignored or removed from consideration in selecting an adsorbent material 122 from the plurality of adsorbent materials 122. For each iteration, the filling of the storage vessel 110 with gas generates heat due to the compression of the gas. Because the level of adsorption by the adsorbent material 122 reduces as the temperature increases, the storage vessel 110 can be allowed to cool between iterations. In one exemplary implementation, the storage vessel 110 can be permitted to cool to an ambient temperature prior to the subsequent iteration. It is contemplated that, according to some aspects, the system 100 can include a first temperature sensor to measure the ambient temperature and/or a second temperature sensor to measure the temperature of the storage vessel 110. According to alternative aspects, the operator can wait for an amount of time determined to be sufficient to allow the storage vessel 110 to cool to the ambient temperature before beginning the next iterative filling of the storage vessel 110.

It is contemplated that, according to some aspects of the present disclosure, each of the plurality of adsorbent materials 122 can be disposed in the same storage vessel 110 for evaluation. After one adsorbent material 122 has been evaluated (e.g., after block 224), the adsorbent material 122 can be removed from the storage vessel 110 so the next adsorbent material 122 can be disposed in the storage vessel at block 214.

According to alternative aspects of the present disclosure, a plurality of storage vessels 110 can be provided such that each of the adsorbent materials 122 is disposed in a respective one of the plurality of storage vessels 110. In this way, there is no need to remove an adsorbent material 122 from a storage vessel 110 prior to evaluating the next adsorbent material 122. However, in such instances, the empty-vessel weight of each storage vessel 110 can be determined for the evaluation of the adsorbent material 122 to be disposed in the respective storage vessel 110. In some instances, all of the plurality of storage vessels 110 can have approximately the same dimensions. In other instances, one or more of the plurality of storage vessels 110 can have different dimensions from other ones of the plurality of storage vessels 110.

The foregoing discussion discloses and describes exemplary embodiments of the present invention. One skilled in the art will readily recognize from such discussion, and from the accompanying drawings and claims that various changes, modifications and variations may be made therein without departing from the spirit and scope of the inventions as defined in the following claims. For example, while the systems and methods described and illustrated above relate to the storage of natural gas, it is contemplated that other gases can be utilized in the systems and methods of the present application. Additionally, for example, while functions are described above for a computing device, it is contemplated that some functions of the computing device can be partially or wholly replaced by a manual operation.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

1. A method for optimizing storage of natural gas in a storage vessel, the storage vessel having a valve for controlling ingress and egress of gases for the storage vessel, the storage vessel having an empty-vessel weight, the method comprising:
providing a plurality of adsorbent materials, the plurality of adsorbent materials each having at least one of a different density and a different mesh size;
for each of the plurality of adsorbent materials:
disposing the adsorbent material in the storage vessel,
determining an intermediate-vessel weight of the storage vessel and the adsorbent material disposed within the storage vessel,
filling the storage vessel with natural gas until a predetermined pressure is achieved within the storage vessel, a first portion of the natural gas being adsorbed by the adsorbent material,
determining a first filled-vessel weight of the storage vessel filled with the natural gas to the predetermined pressure and the adsorbent material,
opening the valve to allow the natural gas to egress from the storage vessel until natural gas substantially ceases to egress from the storage vessel, a second portion of the adsorbed natural gas remaining adsorbed by the adsorbent material after the natural gas has substantially ceased to egress from the storage vessel,
after the natural gas has substantially ceased to egress from the storage vessel, determining a first deadsorbed weight of the storage vessel, the adsorbent material, and the second portion of the natural gas,
determining an adsorption rate based on the first filled-vessel weight and the intermediate-vessel weight,
determining a deadsorption rate based on the first filled-vessel weight and the first deadsorbed weight,
determining a density of the adsorptive material based on the empty-vessel weight and the intermediate-vessel weight; and
selecting one of the plurality of adsorbent materials by comparing the adsorption rates, the deadsorption rates, and the densities determined for each of the plurality of adsorptive materials.

2. The method of claim 1, further comprising for each of the plurality of adsorbent materials:
refilling the storage vessel with natural gas until the predetermined pressure is achieved within the storage vessel;
determining a second filled-vessel weight of the storage vessel filled with the natural gas to the predetermined pressure;
in response to the determining the second filled-vessel weight, opening the valve to allow the natural gas to egress from the storage vessel until natural gas substantially ceases to egress from the storage vessel;
after the natural gas has substantially ceased to egress from the storage vessel, determining a second deadsorbed weight of the storage vessel;
determining a second adsorption rate based on the second filled-vessel weight and the first deadsorbed weight; and
determining a second deadsorption rate based on the second filled-vessel weight and the second deadsorbed weight.

3. The method of claim 1, further comprising repeating for a plurality of iterations the filling of the storage vessel, the determining of the filled-vessel weight, the opening of the valve, and the determining of the deadsorbed weight to determine a plurality of adsorption rates and deadsorption rates for each of the plurality of adsorbent materials.

4. The method of claim 3, further comprising confirming a consistent performance pattern for each of the adsorbent materials by removing outlier data from the comparing to select one of the plurality of adsorbent materials.

5. The method of claim 3, further comprising allowing the storage vessel to cool to approximately an ambient temperature between each of the plurality of iterations.

6. The method of claim 1, wherein the comparing comprises determining which of the plurality of an adsorbent materials have a rate of adsorption above a first predetermined threshold, a rate of deadsorption above a second predetermined threshold, and a density below a third predetermined threshold.

7. The method of claim 1, wherein the predetermined pressure is approximately 250 pounds per square inch to approximately 900 pounds per square inch.

8. The method of claim 1, wherein the plurality of adsorbent materials comprises a plurality of different activated carbon materials.

9. The method of claim 1, wherein the storage vessel comprises a plurality of storage vessels and each of the plurality of adsorbent materials is disposed in a different one of the plurality of different storage vessels.

10. The method of claim 9, further comprising determining the empty-vessel weight of each of the plurality of storage vessels.

11. The method of claim 9, wherein at least one of the plurality of storage vessels has a different size than another of the plurality of storage vessels.

12. The method of claim 1, further comprising prior to filling the storage vessel with one of the plurality of adsorbent materials, removing a prior one of the plurality of adsorbent materials from the storage vessel.

13. A system for optimizing storage of natural gas in a storage vessel, comprising:
at least one storage vessel including a shut-off valve configured to control the ingress and egress of gases from the at least one storage vessel;
a gas supply source selectively coupled to the storage vessel to supply gas to the at least one storage vessel;
a pressure gauge to measure a pressure within the at least one storage vessel;
a plurality of adsorbent materials, each of the plurality of adsorbent materials being separately disposed in the at least one storage vessel for individual evaluation;
a measurement device configured to determine at least one of a weight or a mass of at least the at least one storage vessel; and
a computing device communicatively coupled to the measurement device and configured to process information received based on the measured weight or mass determined by the measurement device, the computing device being configured to determine a density, an adsorption capacity, and a deadsorption rate of each adsorbent material disposed in the at least one storage vessel based on information determined by the measurement device.

14. The system of claim 13, wherein the measurement device is configured to generate a measurement signal indicative of the measured weight or mass, and the measurement device is directly communicatively coupled to the computing device so as to receive and process the measurement signal.

15. The system of claim 13, wherein the computing device includes one or more processors and one or more memory devices storing instructions that, when executed by the one or more processors, cause the system to, for each adsorbent material:
determine an intermediate-vessel weight of the storage vessel and the adsorbent material disposed within the storage vessel,
fill the storage vessel with natural gas until a predetermined pressure is achieved within the storage vessel, a first portion of the natural gas being adsorbed by the adsorbent material,
determine a first filled-vessel weight of the storage vessel filled with the natural gas to the predetermined pressure and the adsorbent material,
open the valve to allow the natural gas to egress from the storage vessel until natural gas substantially ceases to egress from the storage vessel, a second portion of the adsorbed natural gas remaining adsorbed by the adsorbent material after the natural gas has substantially ceased to egress from the storage vessel,
after the natural gas has substantially ceased to egress from the storage vessel, determine a first deadsorbed weight of the storage vessel, the adsorbent material, and the second portion of the natural gas,
determine an adsorption rate based on the first filled-vessel weight and the intermediate-vessel weight,
determine a deadsorption rate based on the first filled-vessel weight and the first deadsorbed weight, and
determine a density of the adsorptive material based on the empty-vessel weight and the intermediate-vessel weight.

16. The system of claim 15, wherein the computing device is further configured to select one of the plurality of adsorbent materials by comparing the adsorption rates, the deadsorption rates, and the densities determined for each of the plurality of adsorptive materials.

17. The system of claim 16, wherein the comparing comprises determining which of the plurality of an adsorbent materials have a rate of adsorption above a first predetermined threshold, a rate of deadsorption above a second predetermined threshold, and a density below a third predetermined threshold.
